(19) United States
(12) Patent Application Publication
(10) Pub. No.: US 2005/0026027 A1
(43) Pub. Date: Feb. 3, 2005

(54) Fuel cell system

(75) Inventor: Yuusuke Sato, Bunkyo-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/870,179

(22) Filed: Jun. 18, 2004

(30) Foreign Application Priority Data
Jun. 19, 2003 (JP) 2003-175514

(51) Int. Cl. H01M 2/14; H01M 2/00; H01M 2/02; H01M 8/04; H01M 8/10; H01M 8/12; H01M 8/18

(52) U.S. Cl. 429/38; 429/34; 429/39; 429/19; 429/20; 429/26

(57) ABSTRACT

A fuel cell system is provided with one or more fuel cells, each fuel cell including an anode, electrolyte membranes put on both faces of the anode and cathodes respectively put on the electrolyte membranes and a case enclosing the fuel cells so as to leave an air flow path for air supply to the cathodes. The cathode receives air flowing in the air flow path so as to generate electricity.

### CROSS-REFERENCE TO RELATED APPLICATIONS

This application is based upon and claims the benefit of priority from the prior Japanese Patent Application No. 2003-175514 (filed Jun. 19, 2003); the entire contents of which are incorporated herein by reference.

### BACKGROUND OF THE INVENTION

1. Field of the Invention

The present invention relates to a fuel cell system and more particularly to a small-sized fuel cell system capable of generating large electric power.

2. Description of the Related Art

A fuel cell is provided with a membrane electrode assembly (“MEA” hereinafter), which is provided with a cathode, an anode and a polymer electrolyte membrane put therebetween. The MEA is further put between a pair of separators having electric conductivity. When generating electric power, an oxidant such as air is supplied to the cathode. There is disclosed an art of a method as such air supply, in which the air is supplied by means of diffusion. An art related to this art is disclosed in Japanese Patent Application Laid-open No. 2000-58072. Another art is further disclosed, in which serpentine flow path is formed in the separator and the air is supplied therein by a pump. An art related to this art is disclosed in Japanese Patent Application Laid-open No. 2003-86230.

Among the aforementioned related arts, the former method does not need a pump for supplying the air and therefore a fuel cell system can be constituted in a small size. However, it is difficult to supply a large amount of air to the cathode to generate large electric power according to the method. It is further difficult to get heat radiation efficiency corresponding to heat generation and therefore temperature of the fuel cell is uneasy to be regulated in a proper range. Therefore it is difficult to generate the large electric power.

According to the aforementioned latter method, it is easy to supply an enough amount of air to the cathode to generate large electric power. However, the serpentine flow path causes a large pressure drop so that a pump having large capacity should be provided. Such a pump causes a large power consumption, large noise and difficulty for down-sizing.

### SUMMARY OF THE INVENTION

The present invention is intended for solving the above problem and providing a small-sized fuel cell system capable of generating large electric power.

According to a first aspect of the present invention, a fuel cell system is provided with one or more fuel cells, each fuel cell including an anode, one or more electrolyte membranes layered on the anode and one or more cathodes layered on the electrolyte membranes and a case enclosing the fuel cell so as to leave an air flow path for air supply to the cathodes.

According to a second aspect of the present invention, a fuel cell system is provided with a fuel cell including an anode having first and second sides, en electrolyte membrane layered on the first side and a cathode layered further on the electrolyte membrane and a case, an inner surface of the case being adhered to the second side and the case enclosing the fuel cell so as to leave an air flow path for air supply to the cathode.

### BRIEF DESCRIPTION OF THE DRAWINGS

FIG. 1 is a schematic illustration of a fuel cell system according to a first embodiment of the present invention;

FIG. 2 is a schematic illustration of a fuel cell system according to a second embodiment of the present invention;

FIG. 3 is a schematic illustration of a fuel cell system according to a third embodiment of the present invention;

FIG. 4 is a schematic illustration of a fuel cell system according to a fourth embodiment of the present invention;

FIG. 5 is a schematic illustration of a fuel cell system according to a fifth embodiment of the present invention;

FIG. 6 is a schematic illustration of a fuel cell system according to a sixth embodiment of the present invention;

FIG. 7 is a schematic illustration of a fuel cell system according to a seventh embodiment of the present invention;

FIG. 8 is a perspective view with a partial cross-sectional view of a heat exchanger according to a first version; and

FIG. 9 is a perspective view with a partial cross-sectional view of a heat exchanger according to a second version.

### DETAILED DESCRIPTION OF THE INVENTION

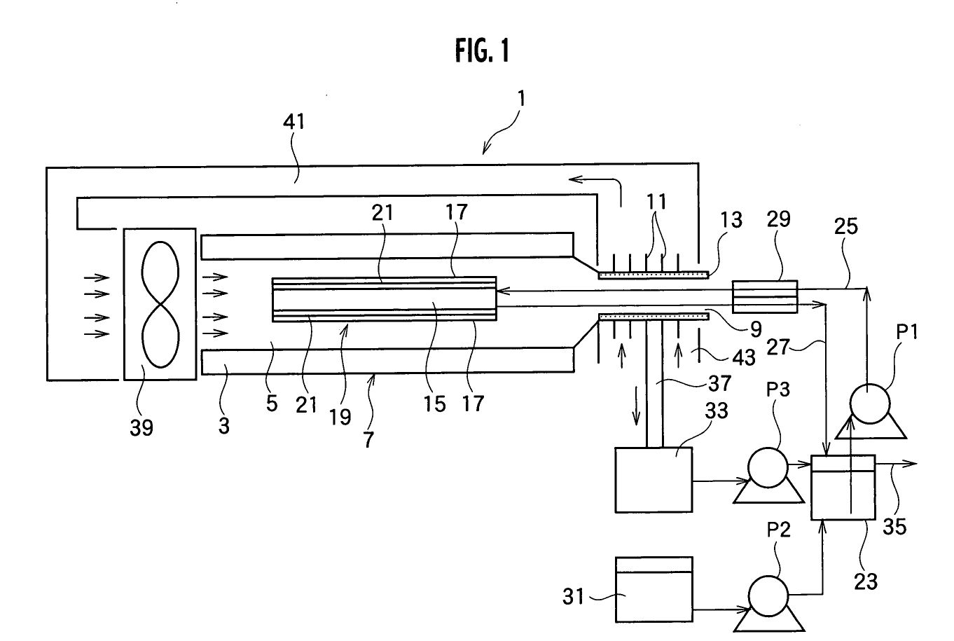

Referring to FIG. 1, a fuel cell system 1 according to a first embodiment of the present invention is provided with a case 7 formed in a tubular shape, which encloses a space 5. Both ends of the space 5 are opened so as to permit an airflow through the space 5 for supplying air as an oxidant. A cross-section thereof preferably has a square or rectangular shape, where the rectangular shape is long sideways and the sideways direction is perpendicular to a plane of the paper of FIG. 1. The cross-sectional shape is not limited to square and rectangular but can be formed in various shapes.

The case 7 is preferably provided with a heat insulator 3 along the case 7 for heat insulation between the interior and the exterior thereof. As the heat insulator 3, various means can be employed. Preferably, heat insulating material such as glass wool, ceramics or foam plastic can be applied. Alternatively, a thin airtight chamber, an interior of which is kept in a vacuum or filled with heat insulating gas such as carbon dioxide or xenon, can be applied.

An outflow path 9 is connected to one end of the case 7 and has a cross-sectional area less than a cross-sectional area of the space 5. An outer periphery of the outflow path 9 is provided with a heat exchanging unit 11 such as fins. An inner periphery of the outflow path 9 is provided with a water absorbent member 13 such as a wick.

A fuel cell 19 is provided with an anode (a fuel electrode) 15 to which fuel is supplied, a pair of electrolyte membranes 21 respectively layered on both sides of the anode 15 and a pair of cathodes (air electrodes) 17 layered further on both sides thereof. The fuel cell 19 is housed in the case 7 and disposed in the space 5 so as to leave an air flow path for air supply to the cathodes 17 between the fuel cell 19 and the case 7. The anode 15 is provided with a flow path of a conductive material. The fuel flows through the flow path so as to spread all over the anode 15. The cathode 17 is provided with a current collector (not shown) so that the generated electric power is extracted to an external cable (not shown).

For supplying the fuel to the anode 15, a supply flow path 25 such as a pipe connects a mixing tank 23 and the anode 15 and is laid through the outflow path 9. A pump P1 for transmitting the fuel is joined in the supply path 25. A recovery flow path 27 further connects the anode 15 and the mixing tank 23. The supply flow path 25 and the recovery flow path 27 are connected to and pass through a heat exchanger 29. Namely, the fuel supplied to the anode 15 via the supply flow path 25 and fluid flowing through the recovery flow path 27 exchange heat at the heat exchanger 29.

A fuel tank 31 housing methanol as the fuel is connected to the mixing tank 23 via a pump P2. A water tank 33 is further connected to the mixing tank 23 via a pump P3. The mixing tank 23 is provided with an exhaust port 35 so as to exhaust gas therein outward. The water tank 33 houses a porous member such as a sponge therein so as to contain water. A connection channel 37 connects the water absorbent member 13 and the water tank 33 so as to conduct the water contained in the water absorbent member 13 to the water tank 33.

A fan 39 is disposed at the other end, opposite to the outflow path 9, of the space 5 so as to produce flow of air as an oxidant supplied to the cathode 17. An air duct 41 connected to a suction side of the fan 39 is led to the heat exchanging unit 11 and an opening portion 43 of the air duct 41 is disposed at and encircles the heat exchanging unit 11.

When driving the pump P1 so as to supply the fuel in the mixing tank 23 to the anode 15 and also driving the fan 39 so as to supply the air to the cathode 17, the fuel cell 19 generates electricity. Accompanying the generation of the electricity, the fuel cell 19 generates heat. The space 5 encloses the fuel cell 19 so as to reduce heat transmission to the surroundings. Thereby the temperature of the fuel cell 19 is easily regulated in a proper range and the efficiency of the power generation can be increased.

The air introduced into the opening portion 43 exchanges heat with the hot air exhausted from the outflow path 9 so as to be heated and is then supplied to the fuel cell 19. Thereby the fuel cell 19 is prevented from over-cooling and the temperature thereof is further easily regulated.

The air exhausted from the outflow path 9 contains water vapor generated in the fuel cell 19 and is cooled because of the heat exchange so that the water is condensed. The condensed water is absorbed into the water absorbent member 13 and sucked to the water tank 33 by means of negative pressure, which the pump P3 generates in the water tank 33 when supplying water to the mixing tank 23.

Consequently, the water generated in the fuel cell 19 is conducted to the mixing tank 23 and mixed with the fuel therein. In expectation of being diluted with the water in the mixing tank 23, highly concentrated fuel (for example, pure methanol) can be utilized and housed in the fuel tank 31. Therefore the fuel tank 31 as well as the water 33 can be small-sized. Moreover, the fuel cell system as a whole can be small-sized.

Furthermore, the fuel supplied from the mixing tank 23 by means of the pump P1 exchanges heat with the hot fluid containing unreacted methanol, water, and carbon dioxide exhausted from the anode 15 through the recovery flow path 27 so as to be heated and is then supplied to the anode 15. Thereby the fuel cell 19 is prevented from over-cooling and the temperature thereof is further easily regulated.

The space 5 has a linear configuration so that the flow of the air supplied by the fan 39 is hardly obstructed by anything except for the fuel cell 19 from the inflow opening to the outflow path 9 and has relatively small pressure drop. Therefore the fan 39 can also small-sized and the consumption of the electricity can be reduced. The fuel cell system as a whole can be further small-sized.

The water introduced from the water tank 33 and the fuel introduced from the fuel tank 31 are so mixed in the mixing tank 23 as to be a proper concentration, which the fuel cell 19 generates power efficiently.

In contrast to the above description, the air duct 41 connected to the opening portion 43 may be omitted. As well, the aforementioned configuration that the outflow path 9 is configured to collect the water contained in the exhaust gas, may be omitted and another source of the water may be provided instead. Furthermore, the heat exchanger 29 may be omitted.

A rate of feeding air by the fan 39 may be fixed or, where necessary, changed so as to regulate the temperature of the fuel cell 19 or the amount of water which the fed air carries away from the fuel cell 19.

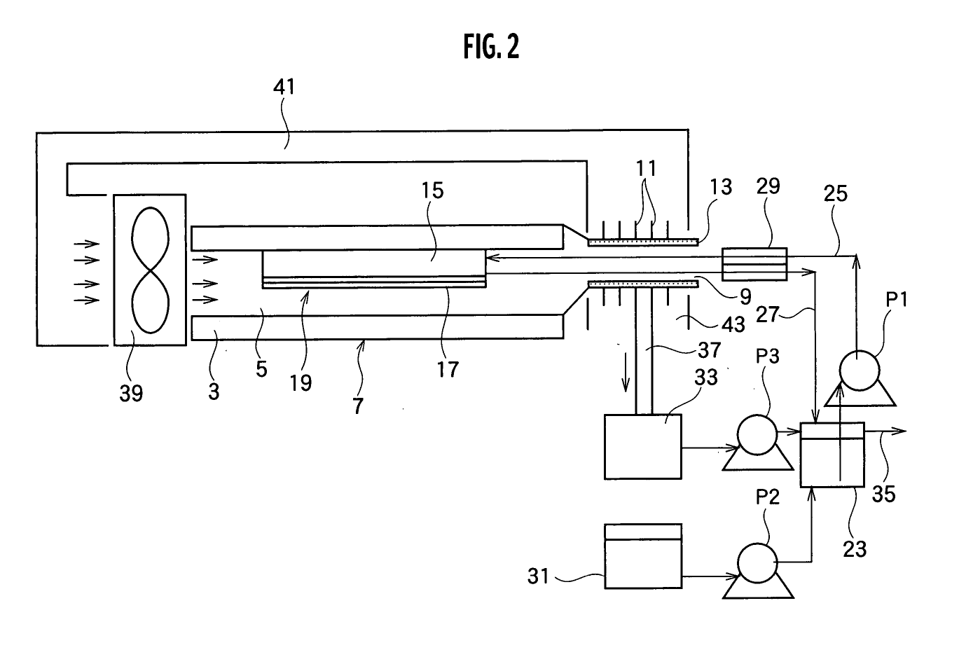

A second embodiment of the present invention will be described hereinafter with reference to FIG. 2. In the following description, substantially the same elements as the aforementioned description are referenced with the same numerals and the detailed descriptions are omitted.

As compared with the above first embodiment, one set of the cathode 17 and the electrolyte membrane 21 is omitted and the anode 15 is supported by the inner surface of the case 7. Either direct adhesion or any support member interposed therebetween may be employed as an aspect of the support manner. As well as having the same effect as the above first embodiment, the second embodiment makes the fuel cell system as a whole further small-sized because the case 7 can be constituted in a thinner shape.

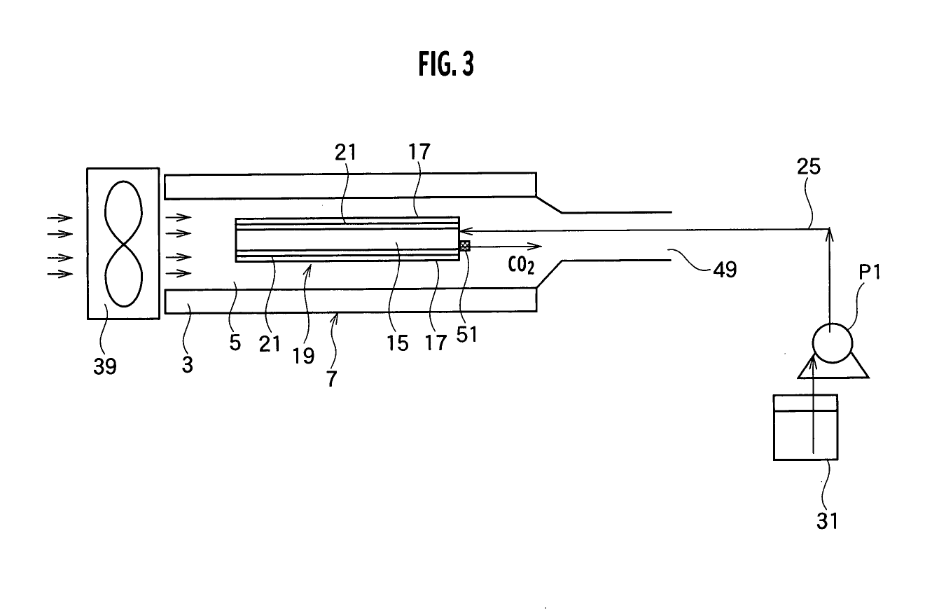

A third embodiment of the present invention will be described hereinafter with reference to FIG. 3. In the following description, substantially the same elements as the aforementioned description are referenced with the same numerals and the detailed descriptions are omitted.

As compared with the above first embodiment, the water tank 33, the connection channel 37 connected thereto, the mixing tank 23 and the pumps P2, P3 are omitted and the fuel tank 31 is directly connected to the pump P1. Furthermore, the recovery flow path 27 and the heat exchanger 29 are omitted and CO₂ generated at the anode 15 is separated at a gas-liquid separation membrane 51 provided at end peripheries of the anode 15 and exhausted through the outflow path 59. Moreover, the heat exchanging unit 11 and the air duct 41 having the opening portion 43 encircling the heat exchanging unit 11 are omitted and the air is supplied to the cathode 17 by means of the fan 39 without heat exchange.

According to the present embodiment, the fuel housed in the fuel tank 31 is necessary to be diluted in a proper concentration, which corresponds to a mixing ratio of a quantity of fuel consumed at the anode 15 and a quantity of water consumed at the anode 15, humidifying the electrolyte membranes 21, and partly percolating to the cathode 17, in advance. Therefore it is necessary that the fuel tank 31 is made larger or a capacity of the fuel cell is made smaller as compared with the above first embodiment. Instead, the aforementioned elements can be omitted and therefore the fuel cell system as a whole can be further small-sized.

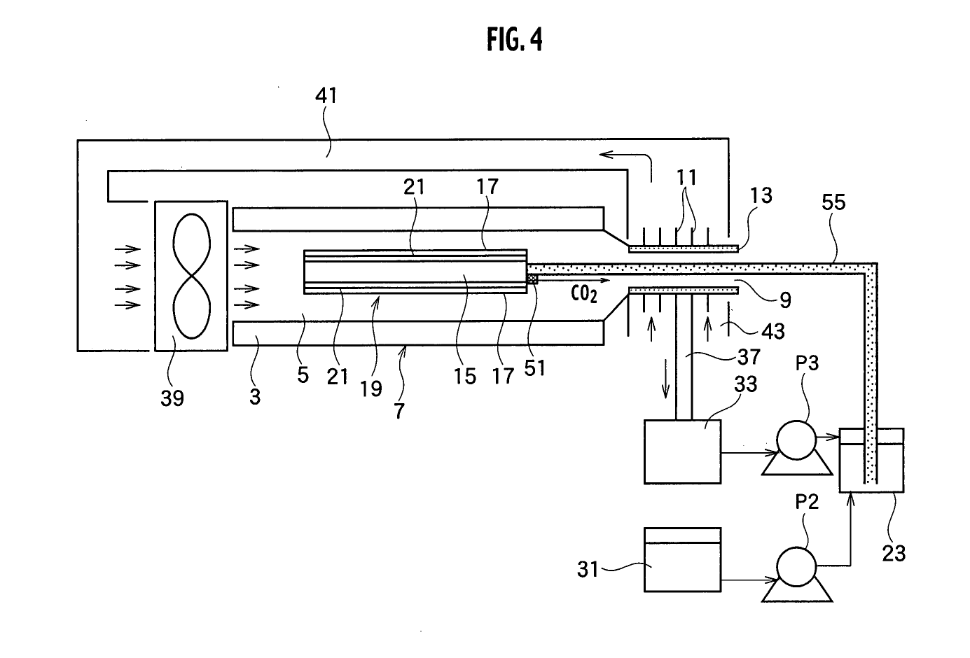

A fourth embodiment of the present invention will be described hereinafter with reference to FIG. 4. In the following description, substantially the same elements as the aforementioned description are referenced with the same numerals and the detailed descriptions are omitted.

As compared with the above first embodiment, the pump P1 is omitted and a porous body 55 such as a sponge links the mixing tank 23 with the anode 15 so as to supply the fuel to the anode 15. Furthermore, the recovery flow path 27 and the heat exchanger 29 are omitted and CO₂ generated at the anode 15 is separated at a gas-liquid separation membrane 51 provided at end peripheries of the anode 15 and exhausted through the outflow path 59. According to the present embodiment, the fuel is conducted by means of capillary force of the porous body 55 so that the pump P1 can be omitted. To this extent, the whole constitution can be simplified.

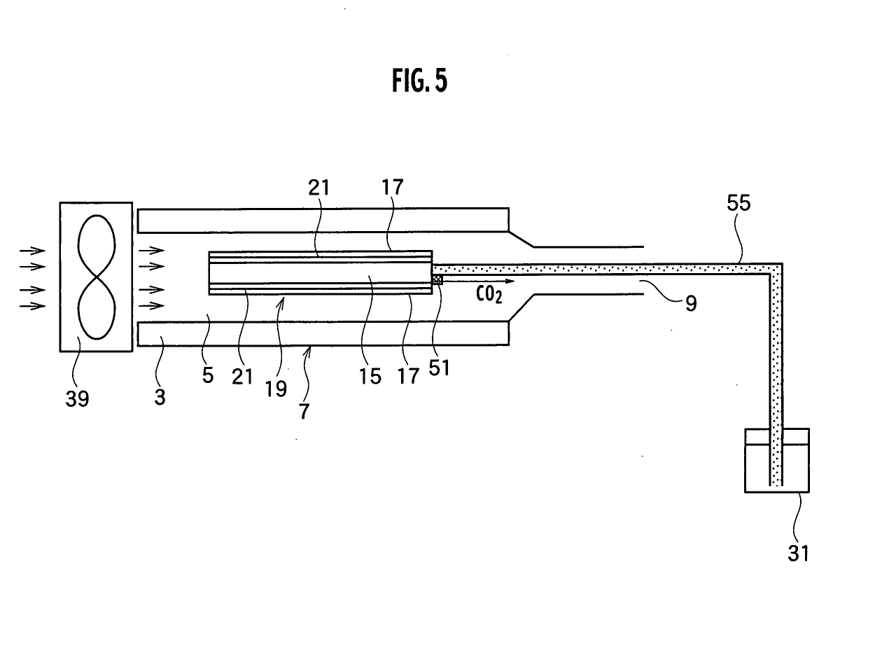

FIG. 5 schematically shows a fifth embodiment of the present invention, which has a further simplified constitution as compared with the above third and fourth embodiments. The water tank 33, the heat exchanging unit 11 and such are omitted so that the fuel is directly supplied from the fuel tank 31 to the anode 15, as is the case with the above third embodiment. A link between the fuel tank 31 and the anode 15 is achieved by the porous body 55, as is the case with the above fourth embodiment.

According to the present embodiment, it is necessary to utilize fuel which is diluted in a proper concentration in advance, like as the third embodiment. Therefore it is necessary that the fuel tank 31 is made larger or the cell capacity is made smaller than the case with the first embodiment. Instead, the constitution is simplified, as is the case with the third embodiment, and can be further simplified because the pump P1 is omitted.

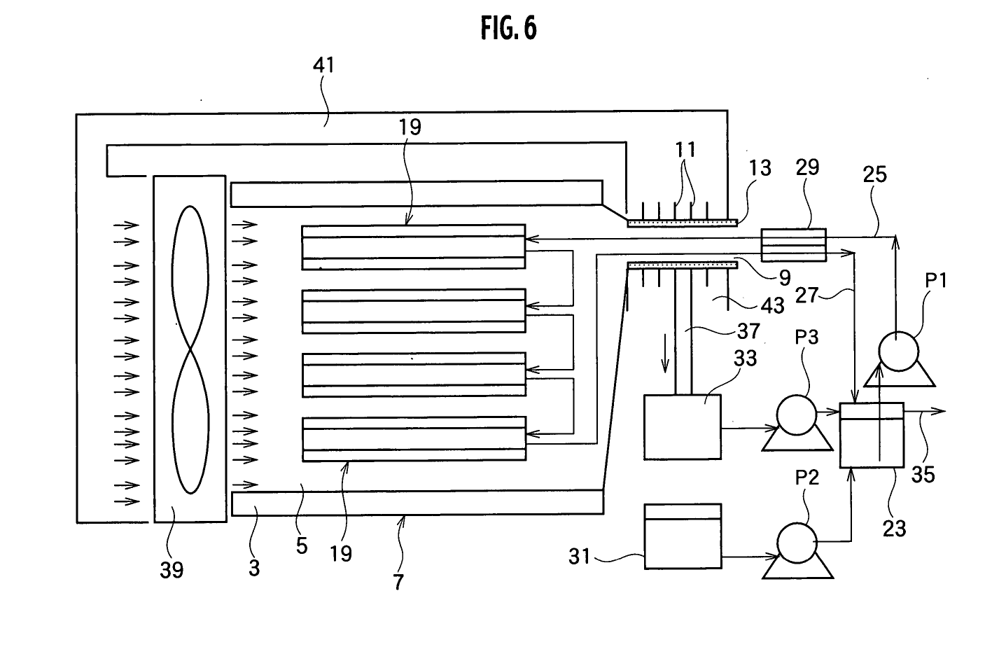

A sixth embodiment of the present invention will be described hereinafter with reference to FIG. 6. In the following description, substantially the same elements as the aforementioned description are referenced with the same numerals and the detailed descriptions are omitted.

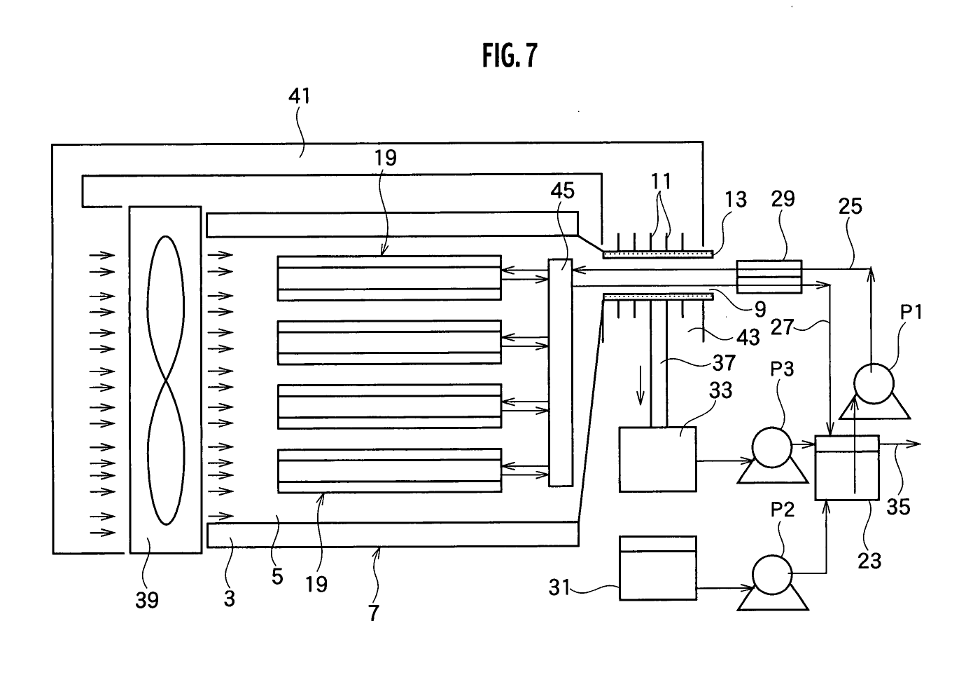

As compared with the above first embodiment, the fuel cell system is provided with a plurality of the fuel cells 19. The fuel cells 19 are arranged in parallel with each other at proper intervals and disposed in the space 5. As shown in FIG. 6, the supply flow path 25 is connected to the first of the fuel cells 19 and the recovery flow path therefrom is connected to the second. There covery flow path from the second is further connected to the third and the rests of the fuel cells 19 are similarly configured. Thereby the fuel cells 19 are connected in series via the flow paths. Alternatively, as a seventh embodiment shown in FIG. 7, a manifold 45 may be provided and the fuel are supplied to the fuel cells 19 via the manifold 45. According to the sixth or seventh embodiment, larger electricity generation can be obtained because the plural fuel cells 19 are provided.

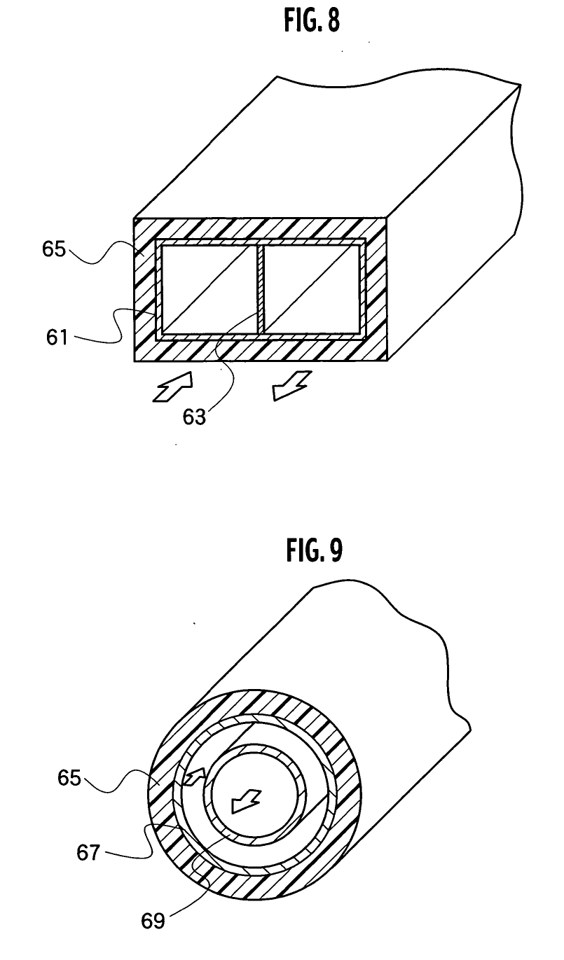

The aforementioned embodiments utilize the heat exchanger 29 to exchange heat between the supply flow path 25 and the recovery flow path 27. As an alternative to such constitutions, to-and-fro tubes so configured as to exchange heat therebetween can be applied. FIG. 8 shows a first version thereof, which is provided with a tube 61 having a rectangular cross section and a partition 63 having high heat conductivity. An interior of the tube 61 is partitioned into two by the partition 63. FIG. 9 shows a second version, which is provided with an outer cylindrical tube 67 and an inner cylindrical tube 69 having high heat conductivity, which are coaxially disposed. A heat insulator 65 may be applied for heat insulation from the surroundings. Respective cavities partitioned by the partition 63 or the inner cylindrical tube 69 serve as the supply flow path 25 and the recovery flow path 27 and exchange heat therebetween.

As being understood from the above description, according to any of the embodiments of the present invention, pressure drop of the air in the space is suppressed. Therefore a small fan is enough for supplying the air to the cathode and for generating relatively large electricity. Down-sizing and getting higher efficiency of the fuel cell can be achieved.

Although the invention has been described above by reference to certain embodiments of the invention, the invention is not limited to the embodiments described above. Modifications and variations of the embodiments described above will occur to those skilled in the art, in light of the above teachings.

1. A fuel cell system comprising:
one or more fuel cells, each fuel cell including an anode, electrolyte membranes put on both faces of the anode and cathodes respectively put on the electrolyte membranes; and
a case enclosing the fuel cells so as to leave an air flow path for air supply to the cathodes.

2. The fuel cell system of claim 1, further comprising:
a fan producing air flow in the case.

3. The fuel cell system of claim 1, further comprising:
a water absorbent member disposed in the case.

4. The fuel cell system of claim 3, further comprising:
a fuel tank housing fuel for the fuel cells;
a water tank connected to the water absorbent member and configured to collect water contained in the absorbent member;
a mixing tank connected to the water tank and configured to mix the collected water with the fuel.

5. The fuel cell system of claim 4, further comprising:
a supply flow path connecting the mixing tank and the anode and supplying the mixed fuel to the anode; and
a recovery flow path connecting the anode and the mixing tank and collecting exhaust from the anode to the mixing tank.

6. The fuel cell system of claim 5, further comprising: p1 a heat exchanger exchanging heat between the supply flow path and the recovery flow path.

7. The fuel cell system of claim 1, further comprising:
a fuel tank housing fuel being regulated in a concentration corresponding to a mixing ratio of a quantity of fuel consumed at the anode and a quantity of water consumed at the anode, humidifying the electrolyte membranes and partly percolating to the cathodes in advance.

8. The fuel cell system of claim 7, wherein:
the supply flow path comprises a porous body and directly connects the fuel tank and the anode.

9. The fuel cell system of claim 1, further comprising:
a heat exchanging unit exchanging heat between inflow air to the case and outflow air from the case.

10. The fuel cell system of claim 1, further comprising:
a fuel tank and a porous body connecting the fuel tank and the anode.

11. The fuel cell system of claim 1, wherein the case comprises heat insulator.

12. A fuel cell system comprising:
a fuel cell including an anode having first and second faces, an electrolyte membrane put on the first face and a cathode put further on the electrolyte membrane; and
a case, an inner surface of the case supporting the second face and the case enclosing the fuel cell so as to leave an air flow path for air supply to the cathode.

13. The fuel cell system of claim 12, further comprising:
a fan producing air flow in the case.

14. The fuel cell system of claim 12, further comprising:
a water absorbent member disposed in the case.

15. The fuel cell system of claim 14, further comprising:
a fuel tank housing fuel for the fuel cells;
a water tank connected to the water absorbent member and configured to collect water contained in the absorbent member;
a mixing tank connected to the water tank and configured to mix the collected water with the fuel.

16. The fuel cell system of claim 15, further comprising:
a supply flow path connecting the mixing tank and the anode and supplying the mixed fuel to the anode; and
a recovery flow path connecting the anode and the mixing tank and collecting exhaust from the anode to the mixing tank.

17. The fuel cell system of claim 16, further comprising:
a heat exchanger exchanging heat between the supply flow path and the recovery flow path.

18. The fuel cell system of claim 12, further comprising:
a heat exchanging unit exchanging heat between inflow air to the case and outflow air from the case.

19. The fuel cell system of claim 12, further comprising:
a fuel tank and a porous body connecting the fuel tank and the anode.

20. The fuel cell system of claim 12, wherein the case comprises heat insulator.
